(19) United States
(12) Patent Application Publication
(10) Pub. No.: US 2010/0035461 A1
(43) Pub. Date: Feb. 11, 2010

(54) System and Method for Detecting Module Presence in an Information Handling System

(76) Inventor: Stuart Allen Berke, Austin, TX (US)

Correspondence Address: HAMILTON & TERRILE, LLP, P.O. BOX 203518, AUSTIN, TX, 78720, US

(21) Appl. No.: 12/187,513

(22) Filed: Aug. 7, 2008

(51) Int. Cl. H01R 3/00

(52) U.S. Cl. 439/489

(57) ABSTRACT

Presence of a module, such as a DIMM, in an information handling system is detected by selectively altering the function of socket pins at opposing ends of the module socket for use in detection of module pins in contact with the socket pins. For example, ground pins at opposing ends of the socket are selectively interfaced with a detection circuit that applies a voltage through a pull up resistor to generate a logic high if the ground pin is not connected to a module ground pin and a logic low if the ground pin is connected to a module ground pin. Presence detection at opposing ends of the module identifies partially inserted modules where one end indicates a ground pin interface while the opposing end does not.

### BACKGROUND OF THE INVENTION

1. Field of the Invention

The present invention relates in general to the field of information handling system modules, and more particularly to a system and method for detecting module presence in an information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are typically built from a plurality of standardized components that interact using standardized protocols. For example, industry standard memory modules, such as JEDEC memory DIMMs, have connectors that fit into sockets included in the motherboard of the information handling system. Module connectors typically snap the module into place in the socket so that the module remains securely attached until removed with a brisk pull. In some instances, modules are additionally held in place with “ears” that snap around the module to hold the module in place. A typical information handling system has a number of module sockets on the motherboard, some of which are populated during manufacture and some of which are not populated but remain open for the addition of more components by an end user. A trend in the industry has been to include greater module socket resources in information handling systems than were used in previous product generations, such as additional sockets for memory DIMMS, hard disk drives (HDDs), IO slots and other components. For example, in 2003, mainstream two CPU socket server information handling systems typically included six DIMM sockets; in 2005, eight socket; in 2008 18 socket; and in 2009, typical two CPU socket server motherboards will include 32 DIMM socket while four CPU socket server motherboards will have as many as 64 DIMM sockets.

One difficulty sometimes faced by information handling system manufacturers and end users is that module connectors inserted in a motherboard sockets sometimes fail to establish a proper electrical interface, such as when the connector is only partially inserted in the socket. The inability to detect improperly inserted connectors makes the device associated with the connector unusable and also effectively hides the inoperable device from the information handling system so that the improper connection is not easily discovered. For example, if a memory module connector only partially inserts into a motherboard socket, the module will not operate, thus diminishing system memory resources, and the information handling system may give no indication of the failure. Even if an end user deduces a memory module failure, complex systems having multiple memory modules will require repeated tests to locate the memory module that is not properly inserted into its socket. Locating an improperly inserted memory module wastes valuable time during manufacture of an information handling system and, if not located, an improperly seated memory module results in a poor user experience.

### SUMMARY OF THE INVENTION

Therefore a need has arisen for a system and method which detects a module's presence and proper insertion into an information handling system.

In accordance with the present invention, a system and method are provided which substantially reduce the disadvantages and problems associated with previous methods and systems for detecting insertion of a module into an information handling system. Socket pins are borrowed from normal functionality to provide module presence detection functionality and then returned to normal functionality for use by an inserted module. Socket pins at opposing ends of the socket are used so that detection of a module pin at the opposing ends indicates complete insertion of the module while detection of a module pin at only one end indicates incomplete insertion of the module.

More specifically, an information handling system is built with plural components, including a CPU to process information and plural sockets disposed in a motherboard to accept modules for communication with the CPU. A selector interfaces with a socket to selectively assign pins of the socket to perform module presence detection or normal module functionality, such as providing a ground. When selected for presence detection, the pins interface with a detector that analyzes signals from the pins to determine if a module is in electrical communication with the pins. For example, a pull up resistor applies a voltage to a socket ground pin selectively interfaced with the detector so that a high logic signal is provided the detector if a module pin is not in communication with the socket ground pin and a low logic signal is provided the detector if a module ground pin interfaces with the socket ground pin. By selectively borrowing socket ground pins associated with opposing ends of the socket, the module presence is detected at both ends to detect partially inserted modules.

The present invention provides a number of important technical advantages. One example of an important technical advantage is that improperly inserted modules are detected with notice provided to an end user of an information handling system to take corrective action. Detection of improperly inserted modules is performed without modifications to the module or deviation from industry standards. The presence of modules in a motherboard socket is detected even before power is applied to the module so that, for instance, an out-of-band processor, such as a BMC, can manage module detection and identify improper insertion, including partial insertion of a module connector in a socket. Detection of a partially inserted module provides notice so that an end user knows which module is involved and even which side of the module is not properly connected. In addition, other module failures are detected and isolated, such as an SPD EEPROM failure where a DIMM is detected and fully inserted but the SPD EEPROM does not respond as expected. By delaying the application of power to modules until the modules are detected as properly inserted, the risk of damage to the modules is reduced and hot-plug capability for the modules is available.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having module presence detection; and

FIG. 2 depicts a circuit diagram of a memory module connector and socket configured to detect insertion of the memory module in the socket.

### DETAILED DESCRIPTION

Module presence in an information handling system socket is checked by borrowing ground pins of opposing ends of the socket to detect an interface between the socket ground pins and the module ground pins. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

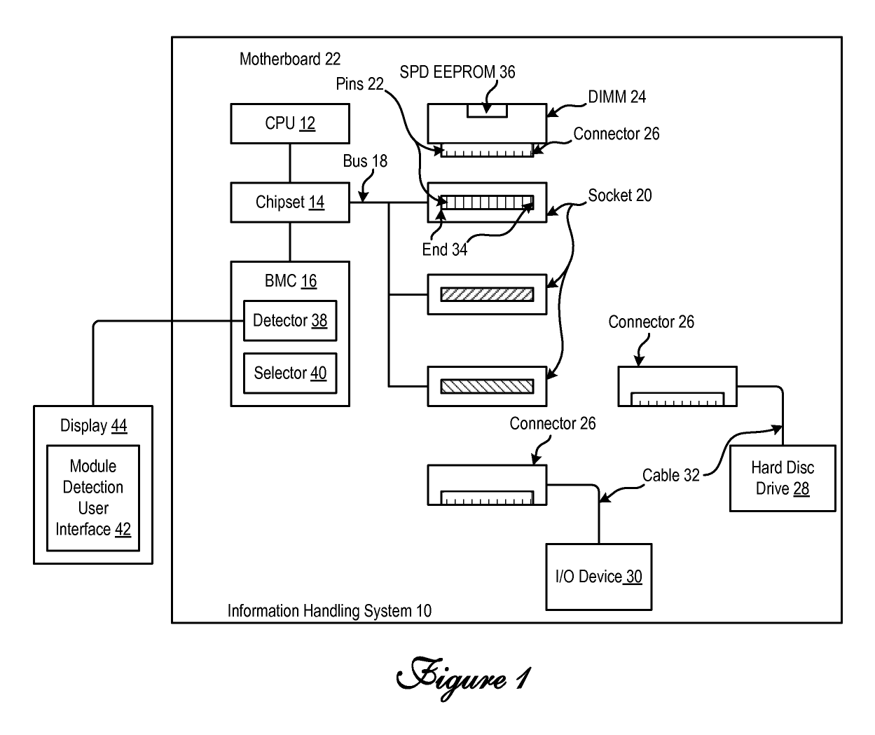

Referring now to FIG. 1, a block diagram depicts an information handling system 10 having module presence detection. Information handling system 10 has a CPU 12 that performs processing operations and a chipset 14 interfaced with CPU 12 to manage interaction of CPU 12 with other components. A baseboard management controller 16 provides out of band management of information handling system 10, such as remote power up and power down. A bus 18 provides communication of information between physical components of information handling system 10, such as communication of information between CPU 12 and memory or other devices inserted in sockets 20 disposed in a motherboard 22. Sockets 20 have pins 22 aligned to interface with pins of devices inserted into the sockets. One example of a device inserted into socket 20 is a memory module 24, such as a dual in-line memory module (DIMM). When a memory module 24 inserts into a socket 20, pins 22 exposed on a connector 26 align to communicate electrical signals with pins 22 within socket 20. Connector 26 engages socket 20 to hold memory module 24 in place. Other types of devices that might engage in a socket 20 include hard disk drives 28 and I/O devices 30 that have connectors 26 disposed at the end of cables 32.

Using a DIMM as an example of a memory module 24, when a DIMM inserts into a socket 20, approximately 240 pins interface from a first end 34 of socket 20 to an opposing end 34. The 240 pins include a variety of data pins that communicate information and approximately 50 to 60 ground pins dispersed among the data pins. After insertion of a DIMM 24 into a socket 20, configuration information read from SPD EEPROM 36 provides chipset 14 with information needed to configure DIMM 24 for use. Difficulty arises with the use of a DIMM 24 when the connector 26 fails to fully insert in a socket 20 so that not all pins 22 of connector 26 establish electrical communication with pins 22 of socket 20. For example, a partially-inserted DIMM 24 is often not detected as present at all so that an end user receives no notice of the partial insertion; however, applying power to less than all pins 22 sometimes results in damage to the DIMM 24. Standards used to define memory modules, such as the JEDEC standard, sometimes fail to include presence pins that are dedicated to detection of the presence of a module in a socket.

In order to detect presence of a module 24 in a socket 20, a selector 40 selects pins 22 on opposing ends 34 of socket 20 to borrow from normal functionality for use in detection of presence of a module 24. Selector 40 removes the pins 22 from the interface for normal functionality to instead interface with a detector 38. Detector 38 analyzes signals from the pins 22 to determine if each pin 22 is in electrical communication with a pin of module 24. If pins 22 on opposing ends 34 of socket 20 are each in communication with module 24, then the module 24 is determined as fully inserted into socket 20. In such an instance, if a failure to communicate with SPD EEPROM 36 is determined, then a notice to the end user is presented at a module detection user interface 42 through a display 44 that module 24 is faulty. If neither pin 22 on opposing ends 34 of socket 20 is detected, the socket 20 is indicated as not having a module 24 inserted. If one end 34 has a pin 22 in communication with the module 24 and the opposing end 34 does not have a pin 22 in communication with the module 24, then a faulty insertion is indicated at module detection user interface 42, including identification of the end that is not fully inserted. Once a determination is made that module 24 is inserted, selector 40 removes the interface of the pins 22 with detector 38 and re-connects the pins 22 used for detection with the normal functionality of the pins. Although FIG. 1 depicts detector 38 and selector 40 as logic within BMC 16, the logic and/or hardware to perform function selection and presence detection may be located in other locations, such as a BIOS supported by chipset 14.

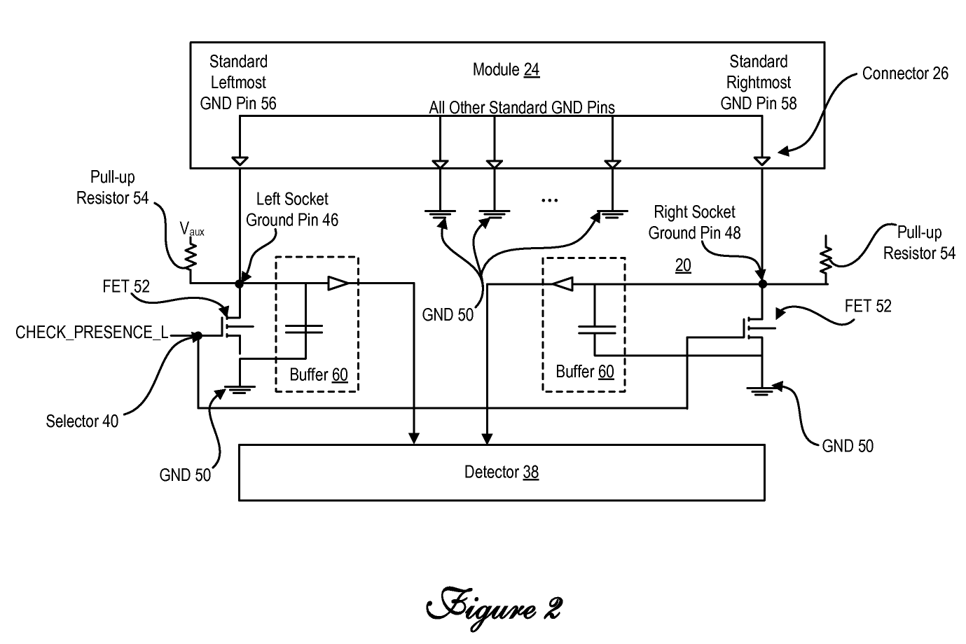

Referring now to FIG. 2, a circuit diagram depicts a memory module connector 26 and socket 20 configured to detect insertion of the memory module 24 in the socket 20. Selector 40 asserts a CHECK_PRESENCE_L signal to remove the interfaces of a left most socket ground pin 46 and right most socket ground pin 48 from an interface with ground 50 to instead interface with detector 38. Field effect transistors (FET) 52 associated with the left most and right most socket pins switch the socket left most ground pin 46 and right most ground pin 48 from an interface with ground 50 at socket 20 to instead interface with detector 38. A pull-up resistor 54 associated with the left most socket ground pin 46 and right most socket ground pin 48 provides a voltage Vaux at each ground pin and into detector 38. If module 24 has a left most ground pin 56 in electrical communication with the left most socket ground pin 46, then the voltage provided from pull-up resistor 54 is grounded to provide a logic low signal to detector 38, indicating insertion of module 24 on the left side. If left socket ground pin 46 is not in electrical communication with the left most ground pin 56 of module 24, then a logic high signal is sent to detector 38, indicating that a module is not inserted in socket 20 on the left side. By performing presence detection with pull up resistor 54 on both the left and right sides of socket 20, detector 38 is able to determine if no module is present or if a module is present but not fully inserted. A buffer circuit 60 reduces inductance of the detection traces to maintain a good return path for AC grounds near high speed signals. Low resistance levels associated with FETs 52, such as one milliohm, keeps DC ground reference shift minimal when the FET is enabled during normal operations. Selectively enabling and disabling FETs 52 allow selective engagement of socket ground pins 46 and 48 with ground 50 to provide normal ground functionality or with detector 38 to perform module detection. Selection of ground pins in socket 20 may use various left or right pins in various embodiments as long as the selected pins are sufficiently close to each of opposing socket ends. Although the exemplary embodiment is illustrated with a memory module, I/O modules, I/O risers, mezzanine cards or other connectors that do not have a dedicated presence pin may use the technique of borrowing ground pins disclosed herein for presence detection. In one embodiment, module hot plug capability is supported by removing power from socket pins until presence is detected as disclosed herein.

Although the present invention has been described in detail, it should be understood that various changes, substitutions and alterations can be made hereto without departing from the spirit and scope of the invention as defined by the appended claims.

1. An information handling system comprising:
a processor operable to process information;
at least one socket interfaced with the processor, the socket having plural pins aligned to electrically communicate with pins of a module connector, the socket having a first ground pin associated with a first end and a second ground pin associated with a second end opposite the first end; and
a detection circuit associated with the socket and operable to selectively interface with the first and second ground pins to detect whether a module connector is in electrical communication with the first and second ground pins.

2. The information handling system of claim 1 further comprising a module having a connector inserted in the socket, the module operable to communicate with the processor.

3. The information handling system of claim 2 wherein the module comprises a DIMM.

4. The information handling system of claim 2 wherein the module comprises a hard disk drive.

5. The information handling system of claim 2 wherein the module comprises an I/O device.

6. The information handling system of claim 1 wherein the detection circuit comprises:
detection logic operable to detect a high signal or a low signal;
first and second field effect transistors operable to selectively interface the first and second ground pins with a ground or with the detection logic;
a first pull-up resistor operable to provide a low signal to the detection logic if the first ground interfaces with a ground of the connector and a high signal if the ground fails to interface with a ground of the connector; and
a second pull-up resistor operable to provide a low signal to the detection logic if the second ground interfaces with a ground of the connector and a high signal if the second ground fails to interface with a ground of the connector.

7. The information handling system of claim 1 wherein the detection circuit is further operable to determine an inoperable module if the first and second ground pins are in electrical communication with the module and predetermined logic of the module fails.

8. The information handling system of claim 7 wherein the module comprises a DIMM and the predetermined logic of the module comprises SPD EEPROM.

9. A method for detecting module presence in an information handling system socket, the method comprising:
interfacing a first socket pin at a first socket end with a detection circuit;
interfacing a second socket pin at a second socket end with a detection circuit;
applying a detection current at the first and second socket pins;
analyzing the detection current with the detection circuit to determine if a first module connector pin interfaces with the first socket pin and a second module connector pin interfaces with the second socket pin; and
removing the interface of the first and second socket pins with the detection circuit to establish an interface of the first and second socket pins with a functional circuit of the socket.

10. The method of claim 9 wherein the first and second socket pins comprise ground pins.

11. The method of claim 10 wherein applying a detection current comprises applying a current to a first pull-up resistor interfaced with the first socket pin and a second pull-up resistor interfaced with the second socket pin.

12. The method of claim 11 wherein analyzing further comprises:
determining that the first or second socket pin interfaces with a module connector ground pin if the current is a logic low signal; and
determining that the first or second socket pin fails to interface with a with a module connector ground pin if the current is a logic high signal.

13. The method of claim 12 wherein the module connector pins comprise DIMM connector pins on opposing ends of a DIMM.

14. The method of claim 13 further comprising:
determining that the first and second pins interface with module connector ground pins; and
attempting communication with EEPROM of the DIMM to test the DIMM functions correctly.

15. The method of claim 9 wherein the detection circuit comprises a baseboard management controller.

16. A system for detecting presence of a module in a socket, the system comprising:
a detection circuit operable to analyze a signal to determine if a pin of the socket interfaces with a pin of a module at each of opposing ends of the socket and module; and
a selector circuit operable to selectively interface socket pins at opposing ends of the socket with a socket function or the detection circuit.

17. The system of claim 16 wherein the socket function comprises providing ground from the socket for the module.

18. The system of claim 16 wherein the detection circuit comprises a pull up resistor interfaced with the socket pin to provide a first signal if the socket pin interfaces with a module pin and a second signal if the socket pin fails to interface with a module pin.

19. The system of claim 16 wherein the module comprises memory.

20. The system of claim 19 wherein the memory comprises a DIMM.
